(19) United States
(12) Patent Application Publication
(10) Pub. No.: US 2026/0289811 A1
(43) Pub. Date: Sep. 24, 2026

(54) NAVIGATION USING HIGH VISIBILITY NON-EPHEMERAL GEOGRAPHIC FEATURES

(71) Applicant: Torc Robotics, Inc., Blacksburg, VA (US)

(72) Inventors: William Gray Davis, Austin, TX (US); Akshay Pai Raikar, Austin, TX (US); Rilwan Remilekun Basaru, Hutto, TX (US); Joseph R. Fox-Rabinovitz, Austin, TX (US)

(21) Appl. No.: 19/086,950

(22) Filed: Mar. 21, 2025

(51) Int. Cl. G06T 7/73; B60W 60/00; G01C 21/30; G06T 7/246

(52) U.S. Cl. CPC G06T 7/73; B60W 60/00; G01C 21/30; G06T 7/246; B60W 2420/403; B60W 2554/20; B60W 2554/80; B60W 2556/50; G06T 2207/10012; G06T 2207/30252

(57) ABSTRACT

An autonomy computing system for an autonomous vehicle includes at least one memory configured to store machine executable instructions, and at least one processor coupled to the at least one memory and configured to execute the machine executable instructions is disclosed. The machine executable instructions configure the at least one processor to: (i) receive a plurality of images captured using an image sensor of the autonomous vehicle; (ii) process a periodic subset of the plurality of images using a machine learning model; (iii) based upon processing by the machine learning model of the plurality of images, determine spatial relationship of a plurality of objects in an environment of an autonomous vehicle comprising the autonomy computing system; and (iv) based upon the determined spatial relationship of the plurality of objects, compute a six degree of freedom (6DOF) of movement in a three-dimensional (3D) space of the autonomous vehicle.

### TECHNICAL FIELD

The field of the disclosure relates to autonomous vehicles and, more specifically, methods of navigation by means of high visibility non-ephemeral geographic features.

### BACKGROUND OF THE INVENTION

Autonomous vehicles employ fundamental technologies such as, perception, localization, behaviors and planning, and control. Perception technologies enable an autonomous vehicle to sense and process its environment. Perception technologies process a sensed environment to identify and classify objects, or groups of objects, in the environment, for example, pedestrians, vehicles, or debris. Localization technologies determine, based on the sensed environment, for example, where in the world, or on a map, the autonomous vehicle is. Localization technologies process features in the sensed environment to correlate, or register, those features to known features on a map. Localization technologies may rely on inertial navigation system (INS) data or Global Navigation Satellite Systems (GNSS) data. Behaviors and planning (or behaviors and motion planning (BMP)) technologies determine how to move through the sensed environment to reach a planned destination. Behaviors and planning technologies process data representing the sensed environment and localization or mapping data to plan maneuvers and routes to reach the planned destination for execution by a controller or a control module. Controller technologies use control theory to determine how to translate desired behaviors and trajectories into actions undertaken by the vehicle through its dynamic mechanical components. This includes steering, braking and acceleration.

Even though GNSS data is considered more accurate than INS data when a clear line of sight to one or more navigation satellites is present; GNSS data may become unreliable due to GNSS signal loss and causes problems that typically can only be solved by a human driver.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY OF THE INVENTION

In one aspect, an autonomy computing system for an autonomous vehicle is disclosed. The autonomy computing system includes at least one memory configured to store machine executable instructions, and at least one processor coupled to the at least one memory and configured to execute the machine executable instructions is disclosed. The machine executable instructions configure the at least one processor to: (i) receive a plurality of images captured using an image sensor of the autonomous vehicle; (ii) process a periodic subset of the plurality of images using a machine learning model; (iii) based upon processing by the machine learning model of the plurality of images, determine spatial relationship of a plurality of objects in an environment of an autonomous vehicle comprising the autonomy computing system; and (iv) based upon the determined spatial relationship of the plurality of objects, compute a six degree of freedom (6DOF) of movement in a three-dimensional (3D) space of the autonomous vehicle.

In another aspect, a computer-implemented method is disclosed. The computer-implemented method includes (i) receiving a plurality of images captured using an image sensor of an autonomous vehicle; (ii) processing a periodic subset of the plurality of images using a machine learning model; (iii) based upon processing by the machine learning model of the plurality of images, determining spatial relationship of a plurality of objects in an environment of an autonomous vehicle comprising the autonomy computing system; and (iv) based upon the determined spatial relationship of the plurality of objects, computing a six degree of freedom (6DOF) of movement in a three-dimensional (3D) space of the autonomous vehicle.

In yet another aspect, an autonomous vehicle including an image sensor, at least one memory configured to store machine executable instructions, and at least one processor communicatively coupled with the at least one memory is disclosed. The at least one processor is configured to execute the machine executable instructions to (i) receive a plurality of images captured using the image sensor; (ii) process a periodic subset of the plurality of images using a machine learning model; (iii) based upon processing by the machine learning model of the plurality of images, determine spatial relationship of a plurality of objects in an environment of an autonomous vehicle comprising the autonomy computing system; and (iv) based upon the determined spatial relationship of the plurality of objects, compute a six degree of freedom (6DOF) of movement in a three-dimensional (3D) space of the autonomous vehicle.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1. is a schematic view of an autonomous truck;

FIG. 2 is a block diagram of the autonomous truck shown in FIG. 1;

FIG. 3 is a block diagram of an example computing system;

FIG. 4 is an example block diagram of a global pose estimation module shown in FIG. 2; and

FIG. 5 is a flow-chart of an example method of navigating an autonomous vehicle by means of high visibility non-ephemeral geographic features.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

Some structural or method features may be shown in specific arrangements and/or orderings in the drawings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments, and, in some embodiments, it may not be included or may be combined with other features.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure.

One or more of the following terms may be used in the disclosure, and their definition is provided below.

An autonomous vehicle: An autonomous vehicle is a vehicle that is able to operate itself to perform various operations such as controlling or regulating acceleration, braking, steering wheel positioning, and so on, without any human intervention. An autonomous vehicle has an autonomy level of level-4 or level-5 recognized by National Highway Traffic Safety Administration (NHTSA).

A semi-autonomous vehicle: A semi-autonomous vehicle is a vehicle that is able to perform some of the driving related operations such as keeping the vehicle in lane and/or parking the vehicle without human intervention. A semi-autonomous vehicle has an autonomy level of level-1, level-2, or level-3 recognized by NHTSA.

A non-autonomous vehicle: A non-autonomous vehicle is a vehicle that is neither an autonomous vehicle nor a semi-autonomous vehicle. A non-autonomous vehicle has an autonomy level of level-0 recognized by NHTSA.

Mission control: Mission control, as described in the present disclosure, refers to one or more application servers, and one or more database servers communicatively coupled with each other and one or more autonomous vehicles of a fleet. Mission control receives sensor data collected by one or more sensors of the one or more autonomous vehicles of the fleet and transmit data including, but not limited to, trajectory data, described herein, to the one or more autonomous vehicles of the fleet.

Dead reckoning navigation: Dead reckoning navigation is a method of calculating a current position of a vehicle (including an autonomous vehicle) by using a previously known location, estimated speed, direction of travel, and the time elapsed since the last known position such that the current location of the vehicle is estimated based on the movement over time without relying on an external reference point like GPS.

Visual Odometry: Visual odometry (VO) is a computer vision technique that uses camera images to estimate the position and movement of the vehicle, such as, the autonomous vehicle.

The disclosed visual odometry system for autonomous vehicles employs stereo cameras in a feature rich environment to mitigate various problems associated with perception technologies using GNSS data or INS data for determining the autonomous vehicle’s pose, e.g., it’s position and orientation. The disclosed perception pipeline enables accurate global positioning complementary to a stereo visual odometry system and to GNSS availability. The disclosed perception pipeline employs or uses a non-ephemeral geographic feature in one or more modules, including a global yaw estimator, a watchdog, and a global pose estimator, each of which is described in detail below. The modules may be embodied in combination in a single system or implemented separately or alone as independent modules, systems, subsystems, etc. The non-ephemeral geographic feature refers to a feature, a view, or an object that is, for example, temporary and visible or available for a short duration.

Generally, visual odometry is performed using parallax measurements from stereo cameras. The accuracy and precision of such measurements deteriorates due to noise at long distances. For example, for objects that are more than approximately 1500 meters from the stereo cameras, the visual odometry “signal” fades into the noise in the environment. However, in certain scenarios, the dearth of objects in the environment of the autonomous vehicle that can be used for navigation is a significant factor in the quality of visual odometry. The dearth of objects for navigation is generally compensated for by using an expensive tactical grade IMU. However, the disclosed visual odometry system can operate in an area that generally lacks objects to address a drift in global yaw angle in the absence of GNSS. The drift in global yaw angle refers to the unintentional, gradual change in the estimated yaw angle over time, even when the object is stationary or moving at a constant heading, due to accumulated errors in the gyroscope's integration process.

A challenging part of dead reckoning is an estimation of yaw. IMU based techniques can wander due to the accumulation of integrated rate errors. For an automotive grade IMU, rate errors may be on the order of degrees per minute. Because speed measurements are generally fairly accurate, the visual odometry system, as described herein, focuses on estimating or computing absolute yaw from the environment. For example, the disclosed global yaw estimator employs points of interest, e.g., mountains. However, other near-horizon features may also be used by the global yaw estimator. As described herein, mountains close to the direction of travel are preferred for yaw estimation due to low sensitivity to motion induced errors while driving towards, or away from, the mountains. In some examples, feature matching algorithms may be used to determine and identify target points (or points of interest) for yaw estimation.

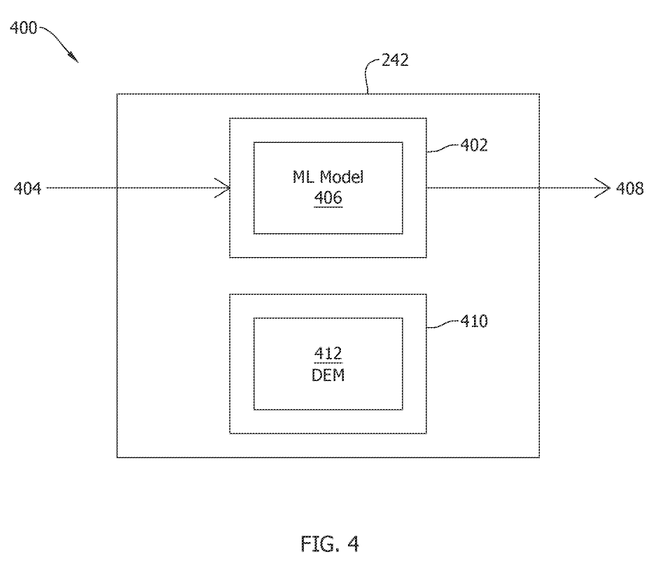

A watchdog, as described herein, is a process that determines the type of imagery available for localization techniques. Depending on the current geographical location of an autonomous vehicle, such as a city, or other environment, that is suitable for stereo-based visual odometry, the watchdog enables a conventional algorithm for localization of the autonomous vehicle. However, when it is determined that the autonomous vehicle is in a desert or plains area, the watchdog switches to an alternative algorithm for long range odometry described in detail below using FIG. 4.

The disclosed watchdog includes a single pipeline to process each incoming frame from the stereo cameras of an autonomous vehicle. In at least some embodiments, the watchdog includes a machine learning (ML) model. The ML model receives an image frame from the stereo cameras as an input and generates an output, for example, that is an integer between zero and one, inclusively. The zero output means the conventional odometry algorithm is good enough to produce good results and a long range odometry algorithm is not required. The output of one means the long range odometry algorithm is required over the conventional odometry algorithm. In some examples, a threshold value, such as 0.5, may be used to determine whether the conventional odometry algorithm or the long range odometry algorithm is to be selected. Accordingly, which odometry algorithm is the most appropriate is determined using the trained ML model. In certain alternative embodiments, the ML model can generate an output on a different scale, e.g., -1 to 1, 0 to 100, etc. In further alternative embodiments, the ML model can generate a non-numeric, e.g., textual indication of which odometry algorithm to employ.

In certain embodiments, the ML model is not required to process each individual frame from the stereo cameras, which may be captured at rates of hundreds or thousands per second. Instead, frames from the stereo cameras are sampled at a lower rate, or processed periodically at a lower frequency, e.g., 1, 10, 20, 50, 100, or 200 frames per second. The rate at which frames are processed can be balanced to yield a desired precision without incurring excessive computational cost. In some examples, when the autonomous vehicle is approaching a city or an area having a number of large static objects (e.g., buildings), the output of the ML model may drop from near 1 to closer to zero gradually as more large static objects come within the range of the stereo cameras. In particular, as more large static objects come within the range of the stereo cameras, the ML algorithm may select the conventional odometry algorithm when the filtered output crossed the threshold value, e.g., 0.5. Similarly, as the autonomous vehicle leaves the city and enters an area where there is dearth of large static object, the ML algorithm may select the long range odometry algorithm. As described herein, static objects on the road such as, occasional road signs or bridges, etc., which are only visible for a fraction of time, e.g., a minute or so, are generally ignored for selecting which odometry algorithm to be used.

In some examples, the ML model is trained to find points of interest that may be used to determine which odometry algorithm should be used. Further, set of points for each odometry algorithm such as, the conventional odometry algorithm or the long range odometry algorithm, may be specific to the odometry algorithm.

The disclosed global pose estimator for an autonomous vehicle includes a computer vision system configured to determine a complete three-dimensional (3D) position and orientation (or pose) in an environment of the autonomous vehicle. The global pose estimator, as described herein, considers spatial relationships of various objects in the environment and the overall scene based upon a plurality of images instead of a single image. The global pose estimator in the present disclosure is based upon full six degrees of freedom (6DOF) estimation system. The 6DOF thus refers to six mechanical degrees of freedom of movement (forward, backward, left, right, up, and down) in a 3D space of the autonomous vehicle.

As described herein, the global pose estimator that uses 6DOF may be tied to or associated with global coordinates associated with a digital elevation model (DEM). In one example, the DEM may be based upon a DEM from the United States Geological Survey (USGS). Further, the DEM may have a granularity of, for example, 30 centimeters, 1 meter, 3 meter, 5 meter, 10 meter, 30 meter, or 60 meter, and comparable vertical accuracy. Additionally, an entire DEM for a route of the autonomous vehicle is not required; instead, a vector layer including only the highest points of a hilly terrain on the road in the region surrounding the autonomous vehicle is required. Even though there are a few thousand such points surrounding the autonomous vehicle along a long route, using only three (3) or more objects (such as high elevation static objects or mountain peaks), the full 6DOF state of the autonomous vehicle may be estimated by a triangulation technique. Further, in regions where the view to the horizon is good, the global pose estimation using the GNSS signal may be complemented or replaced using the global pose estimation based on the full 6DOF as described herein.

Accordingly, the disclosed visual odometry system, including one or more of the global pose estimator, global yaw estimator, and the watchdog provide improved and reliable navigational data when GNSS data is unreliable due to reasons such as GNSS signal loss. Further aspects are described using the following figures.

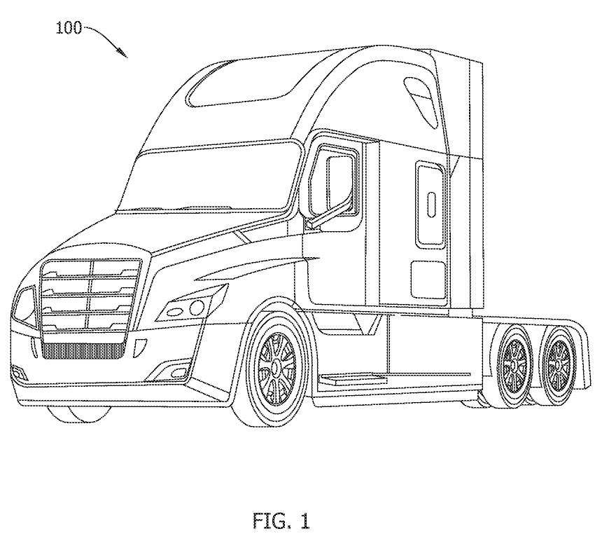

FIG. 1 illustrates a vehicle 100, such as a truck that may be conventionally connected to a single or tandem trailer to transport the trailer (not shown in FIG. 1) to a desired location. The vehicle 100 includes a cabin that can be supported by, and steered in the required direction, by front wheels and rear wheels that are partially shown in FIG. 1. Front wheels are positioned by a steering system that includes a steering wheel and a steering column (not shown in FIG. 1). The steering wheel and the steering column may be located in the interior of cabin.

The vehicle 100 may be an autonomous vehicle, in which case the vehicle 100 may omit the steering wheel and the steering column to steer the vehicle 100. Rather, the vehicle 100 may be operated by an autonomy computing system (not shown in FIG. 1) of the vehicle 100 based on data collected by a sensor network (not shown in FIG. 1) including one or more sensors. The vehicle 100 may be an ego vehicle referenced herein.

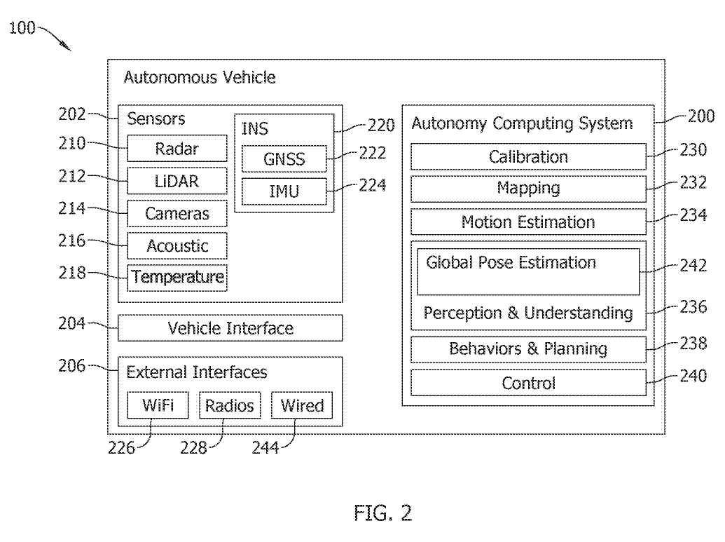

FIG. 2 is a block diagram of autonomous vehicle 100 shown in FIG. 1. In the example embodiment, autonomous vehicle 100 includes autonomy computing system 200, sensors 202, a vehicle interface 204, and external interfaces 206.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, and navigation sensors. Navigation sensors, as described herein, may be one or more inertial navigation system (INS) sensors (or systems) 220, one or more global navigation satellite system (GNSS) sensors 222, or one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 200 to determine how to control operations of autonomous vehicle 100.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be processed to identify one or more construction markers or other objects in the environment surrounding autonomous vehicle 100. In some embodiments, the image data generated by cameras 214 may be sent to autonomy computing system 200 or other aspects of autonomous vehicle 100 or mission control (a hub) or both.

Cameras 214 may have temperature sensors 218 (e.g., one or more of negative temperature coefficient (NTC) thermistors, resistance temperature detectors (RTDs), thermocouples, or semiconductor-based integrated (IC) sensors) positioned on an external surface, or an internal surface, or both, to measure temperature on a camera lens surface of each of cameras 214. Additionally, temperature sensors 218 may be positioned on other areas of the autonomous vehicle 100, e.g., to measure ambient temperature.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. RADAR sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw RADAR sensor data) from the emitted radio waves. In some embodiments, the system inputs from cameras 214, RADAR sensors 210, or LiDAR sensors 212 may be used in combination to identify one or more construction markers (or nodes) around autonomous vehicle 100.

GNSS receiver 222 is positioned on autonomous vehicle 100 and may be configured to determine a location of autonomous vehicle 100, which it may embody as GNSS data. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment. Additionally, or alternatively, GNSS receiver 222 may be configured to receive RTK and GNSS position information from satellite-based systems.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5G, Bluetooth, etc.).

In some embodiments, external interfaces 206 may be configured to communicate with an external network via a wired connection 244, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically, or manually) via external interfaces 206 or updated on demand. In some embodiments, autonomous vehicle 100 may deploy with all of the data it needs to complete a mission (e.g., perception, localization, and mission planning) and may not utilize a wireless connection or other connections while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a control module or controller 240, and global pose estimation module 242. The global pose estimation module 242, for example, may be embodied within another module, such as perception and understanding module 236, behaviors and planning module 238, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100. The global pose estimation module 242 is configured to provide a complete 3D position and orientation (or pose) of the autonomous vehicle.

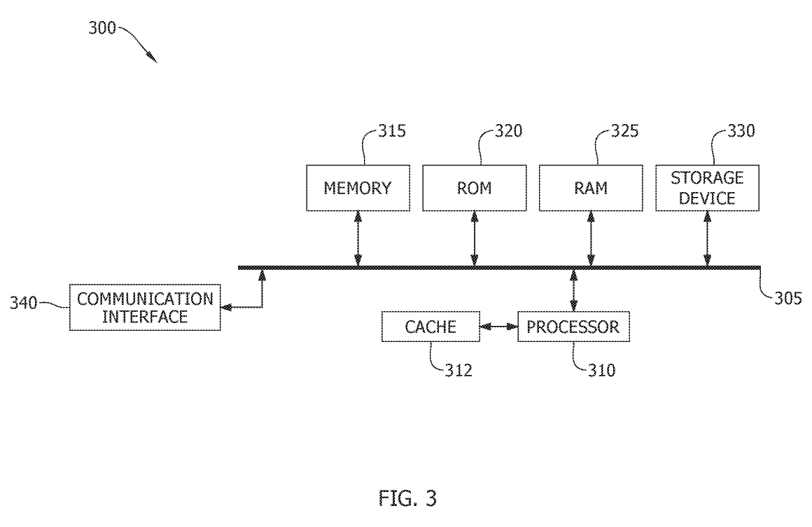

FIG. 3 illustrates an example computing system 300 that can implement various techniques, processes, functions, or methods described herein. Computing system 300 may be embodied within, for example, autonomous vehicle 100 shown in FIG. 1, such as autonomy computing system 200 shown in FIG. 2. The components of computing system 300 are shown in electrical communication with each other using a connection 305, such as a bus. The example computing system 300 includes a processing unit (CPU or processor) 310 and a computing device connection 305 that couples various computing device components, including computing device memory 315, such as a read only memory (ROM) 320 and a random-access memory (RAM) 325, to processor 310.

The processor 310 may be communicatively coupled with a communication interface 340 to communicate with external entities such as, mission control, or one or more other vehicles using V2V communication. Accordingly, the communication interface 340 may include one or more of a radio interface, an electronic sign board mounted on autonomous vehicle 100, a public address system or a loudspeaker positioned at autonomous vehicle 100. The radio interface may be configured for at least one of: (i) a vehicle-to-vehicle communication technique, (ii) citizens band radio frequencies; (iii) a Bluetooth signal; and (iv) a short message service (SMS) technology.

Computing system 300 can include a cache 312 of high-speed memory connected directly with, in close proximity to, or integrated as part of processor 310. Computing system 300 can copy data from memory 315 and/or storage device 330 to cache 312 for quick access by processor 310. In this way, cache 312 can provide a performance boost that avoids processor 310 delays while waiting for data. These and other modules can control or be configured to control processor 310 to perform various actions. Other computing device memory 315 may be available for use as well. Memory 315 can include multiple different types of memory with different performance characteristics. Processor 310 can include any general-purpose processor, central processing unit (CPU), or graphics processing unit (GPU) in combination with a hardware or software provision configured to control processor 310 and stored in storage device 330, as well as any special-purpose processor where software instructions are incorporated into the processor design. Processor 310 may be a self-contained system, containing multiple cores or processors, a bus, memory controller, cache, etc. A multi-core processor may be symmetric or asymmetric.

Storage device 330 is a non-volatile memory and can be one or more of a hard disk or other types of computer readable media that can store data that are accessible by a computer, such as a magnetic cassette, flash memory card, solid state memory device, digital versatile disk, cartridge, RAM 325, ROM 320, or hybrids thereof. Memory 315 or storage device 330 can include software, code, firmware, etc., for controlling processor 310. Other hardware or software modules are contemplated. Memory 315 and storage device 330 are connected to computing device connection 305. In one aspect, a hardware module that performs a particular function can include the software component stored in a computer-readable medium in connection with the necessary hardware components, such as processor 310, computing device connection 305, and so forth, to carry out the function. In the example embodiment, processor 310 may be programmed by encoding an operation or function using one or more executable instructions and providing the executable instructions in memory 315 or storage device 330.

In operation, a computer executes computer-executable instructions embodied in one or more computer-executable components stored on one or more computer-readable media to implement aspects of the disclosure described or illustrated herein. The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

FIG. 4 is an example block diagram 400 of the global pose estimation module 242 (shown in FIG. 2). The global pose estimation module 242 includes implementation of a watchdog 402 that is, as described herein, a process that determines the type of imagery available for localization techniques, and depending on the current geographical location of the autonomous vehicle, such as a city, or other environment, that is suitable for stereo-based visual odometry, the watchdog 402 enables a conventional algorithm for localization of the autonomous vehicle 100 (shown in FIG. 1). Additionally, when it is determined that the autonomous vehicle 100 is in a desert or plains area, the watchdog 402 switches to a different algorithm as described in detail below.

As described herein, the watchdog 402 is implemented to determine a single pipeline to process each incoming frame of a plurality of image frames 404 from the stereo cameras (not shown in FIG. 4). The watchdog 402 that is implemented as a machine learning (ML) model 406 receives an image frame of the plurality of image frames 404 from the stereo cameras as an input and generates an output 408. The output 408 may be an integer between zero and one. The zero output means the conventional odometry algorithm is good enough to produce good results and the long range odometry algorithm is not required. The output of one means the long range odometry algorithm is required over the conventional odometry algorithm. In some examples, a threshold value, such as 0.5, may be used to determine whether the conventional odometry algorithm or the long range odometry algorithm is to be selected. Accordingly, which odometry algorithm is the most appropriate is determined using the trained ML model.

In some examples, the ML model 406 is not required to process each individual frame of the plurality of image frames 404 from the stereo cameras. Instead, frames from the stereo cameras are processed periodically, or at a lower frequency. In some examples, when the autonomous vehicle is approaching a city or an area having a number of large static objects (e.g., buildings), the output of the ML model 406 may drop from near 1 to closer to zero gradually as more large static objects come within the range of the stereo cameras. In particular, as more large static objects come within the range of the stereo cameras, the ML model 406 (or the ML algorithm) may select the conventional odometry algorithm when the filtered output crossed the threshold value, e.g., 0.5. Similarly, as the autonomous vehicle leaves the city and enters an area where there is dearth of large static object, the ML model 406 may select the long range odometry algorithm. As described herein, static objects on the road such as, occasional road signs or bridges, etc., which are only visible for a fraction of time, e.g., a minute or so, are generally ignored for selecting which odometry algorithm to be used.

In some examples, the ML model 406 is trained to find points of interest that may be used to determine which odometry algorithm should be used. Further, set of points for each odometry algorithm such as, the conventional odometry algorithm or the long range odometry algorithm, may be specific to the odometry algorithm.

Additionally, the global pose estimation module 242 includes a global pose estimator 410. The global pose estimator 410 refers to a computer vision system that is configured to determine a complete three-dimensional (3D) position and orientation (or pose) in an environment of the autonomous vehicle. The global pose estimator 410, as described herein, takes into account spatial relationship of various objects in the environment and the overall scene based upon a plurality of images instead of a single image. The global pose estimator in the present disclosure is based upon full six degrees of freedom (6DOF) estimation system. The 6DOF thus refers to six mechanical degrees of freedom of movement (forward, backward, left, right, up, and down) in a 3D space of the autonomous vehicle.

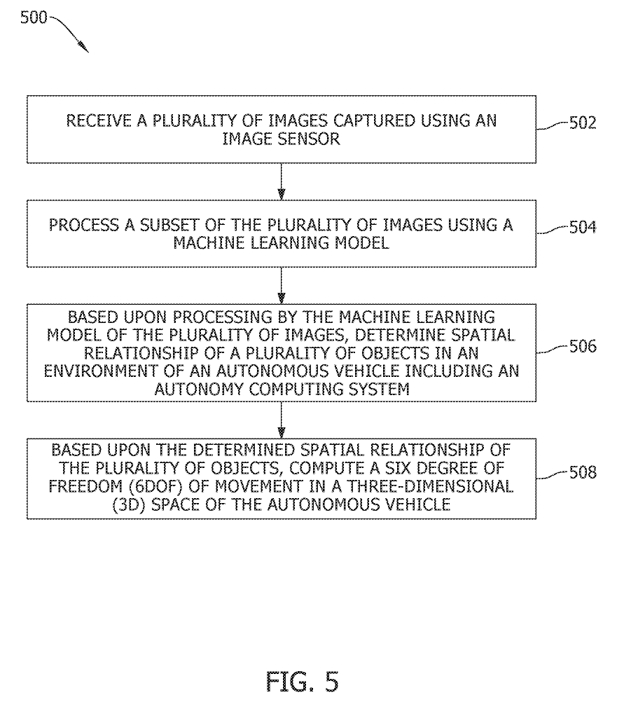

As described herein, the global pose estimator 410 that uses 6DOF is tied to, or associated with, global coordinates associated with a digital elevation model (DEM) 412. In one example, the DEM 412 may be based upon a DEM from the USGS. Further, as described herein, the DEM 412 may have a granularity of 30 centimeters and comparable vertical accuracy. The DEM 412 may include a vector layer including only the highest or craggiest points on the road in the region surrounding the autonomous vehicle. Further, even though there are a few thousand such points surrounding the autonomous vehicle along a long route, only three (3) or more mountain peaks are used for estimating the full 6DOF state of the autonomous vehicle using a triangulation technique. In one example, to determine or estimate the full 6DOF state, an angle of each pixel in the image may be determined, and the angle of each pixel is then used to determine an angle of mountains or the highest or craggiest points in the image. Since the position of the mountains or the highest or craggiest points is known, using the triangulation technique with the known position of 3 or more mountains or the highest or craggiest points, the current position of the autonomous vehicle or the full 6DOF state of the autonomous vehicle may be determined. FIG. 5 is a flow-chart 500 of an example method of navigating an autonomous vehicle by means of high visibility non-ephemeral geographic features. The method may be performed by an autonomy computing system (shown in FIG. 2) or by a computing system (shown in FIG. 3, which may be an application server). The method includes receiving 502 a plurality of images captured using the image sensor. The image sensor may be a stereo camera system of an autonomous vehicle. The method includes processing 504 a periodic subset of the plurality of images using a machine learning model, as described herein.

The method includes determining 506 spatial relationship of a plurality of objects in an environment of the autonomous vehicle. The spatial relationship is determined based upon processing by the machine learning model of the plurality of images. The method includes computing 508 a six degree of freedom (6DOF) of movement in a three-dimensional (3D) space of the autonomous vehicle. The 6DOF movement is computed based upon the determined spatial relationship of the plurality of objects, for example, using three or more objects in the environment of the autonomous vehicle. By way of an example, the three or more objects include high elevation static objects, and the high elevation static objects may include mountain peaks.

Additionally, the 6DOF of movement may be computed in the 3D space of the autonomous vehicle using a triangulation technique, as described herein. The 6DOF of movement in the 3D space of the autonomous vehicle is associated with global coordinates associated with a digital elevation model (DEM), as described herein. Accordingly, global pose estimation using a GNSS signal may be complemented or replaced with global pose estimation based on the 6DOF of movement in the 3D space of the autonomous vehicle.

Accordingly, using the global pose estimator and the watchdog, as described herein, various drawbacks of the visual odometry are solved.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a program, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random-access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

Although certain embodiments have been illustrated and described herein for ‎purposes of description, a wide variety of alternate and/or equivalent embodiments or ‎implementations calculated to achieve the same purposes may be substituted for the ‎embodiments shown and described without departing from the scope of the present disclosure. ‎This application is intended to cover any adaptations or variations of the embodiments ‎discussed herein, including the implementation or utilization of components of the systems or steps independently and separately from other described components or steps. Therefore, it is manifestly intended that embodiments described herein be ‎limited only by the claims.

What is claimed is:

1. An autonomy computing system for an autonomous vehicle, the autonomy computing system comprising:
at least one memory configured to store machine executable instructions; and
at least one processor coupled to the at least one memory and configured to execute the machine executable instructions to configure the at least one processor to:
receive a plurality of images captured using an image sensor of the autonomous vehicle;
process a periodic subset of the plurality of images using a machine learning model;
based upon processing by the machine learning model of the plurality of images, determine spatial relationship of a plurality of objects in an environment of an autonomous vehicle comprising the autonomy computing system; and
based upon the determined spatial relationship of the plurality of objects, compute a six degree of freedom (6DOF) of movement in a three-dimensional (3D) space of the autonomous vehicle.

2. The autonomy computing system of claim 1, wherein the 6DOF of movement is computed using three or more objects in the environment of the autonomous vehicle.

3. The autonomy computing system of claim 2, wherein the three or more objects include high elevation static objects.

4. The autonomy computing system of claim 3, wherein the high elevation static objects include mountain peaks.

5. The autonomy computing system of claim 1, wherein the at least one processor is further configured to execute the machine executable instructions to configure the at least one processor further to: compute the 6DOF of movement in the 3D space of the autonomous vehicle using a triangulation technique.

6. The autonomy computing system of claim 5, wherein the at least one processor is further configured to execute the machine executable instructions to configure the at least one processor further to: associate the 6DOF of movement in the 3D space of the autonomous vehicle with global coordinates associated with a digital elevation model (DEM).

7. The autonomy computing system of claim 5, wherein the at least one processor is further configured to execute the machine executable instructions to configure the at least one processor further to: complement or replace global pose estimation using a GNSS signal with global pose estimation based on the 6DOF of movement in the 3D space of the autonomous vehicle.

8. A computer-implemented method comprising:
receiving a plurality of images captured using an image sensor of an autonomous vehicle;
processing a periodic subset of the plurality of images using a machine learning model;
based upon processing by the machine learning model of the plurality of images, determining spatial relationship of a plurality of objects in an environment of an autonomous vehicle comprising the autonomy computing system; and
based upon the determined spatial relationship of the plurality of objects, computing a six degree of freedom (6DOF) of movement in a three-dimensional (3D) space of the autonomous vehicle.

9. The computer-implemented method of claim 8, wherein the 6DOF of movement is computed using three or more objects in the environment of the autonomous vehicle.

10. The computer-implemented method of claim 9, wherein the three or more objects include high elevation static objects.

11. The computer-implemented method of claim 10, wherein the high elevation static objects include mountain peaks.

12. The computer-implemented method of claim 8, further comprising computing the 6DOF of movement in the 3D space of the autonomous vehicle using a triangulation technique.

13. The computer-implemented method of claim 12, further comprising associating the 6DOF of movement in the 3D space of the autonomous vehicle with global coordinates associated with a digital elevation model (DEM).

14. The computer-implemented method of claim 12, further comprising complementing or replacing global pose estimation using a GNSS signal with global pose estimation based on the 6DOF of movement in the 3D space of the autonomous vehicle.

15. An autonomous vehicle comprising:
an image sensor;
at least one memory configured to store machine executable instructions; and
at least one processor coupled to the at least one memory and configured to execute the machine executable instructions to configure the at least one processor to:
receive a plurality of images captured using the image sensor;
process a periodic subset of the plurality of images using a machine learning model;
based upon processing by the machine learning model of the plurality of images, determine spatial relationship of a plurality of objects in an environment of an autonomous vehicle comprising the autonomy computing system; and
based upon the determined spatial relationship of the plurality of objects, compute a six degree of freedom (6DOF) of movement in a three-dimensional (3D) space of the autonomous vehicle.

16. The autonomous vehicle of claim 15, wherein the 6DOF of movement is computed using three or more objects in the environment of the autonomous vehicle.

17. The autonomous vehicle of claim 16, wherein the three or more objects include high elevation static objects, and wherein the high elevation static objects include mountain peaks.

18. The autonomous vehicle of claim 15, wherein the at least one processor is further configured to execute the machine executable instructions to configure the at least one processor further to: compute the 6DOF of movement in the 3D space of the autonomous vehicle using a triangulation technique.

19. The autonomous vehicle of claim 18, wherein the at least one processor is further configured to execute the machine executable instructions to configure the at least one processor further to: associate the 6DOF of movement in the 3D space of the autonomous vehicle with global coordinates associated with a digital elevation model (DEM).

20. The autonomous vehicle of claim 18, wherein the at least one processor is further configured to execute the machine executable instructions to configure the at least one processor further to: complement or replace global pose estimation using a GNSS signal with global pose estimation based on the 6DOF of movement in the 3D space of the autonomous vehicle.
